(19) United States
(12) Patent Application Publication
(10) Pub. No.: US 2008/0079260 A1
(43) Pub. Date: Apr. 3, 2008

(54) Pipeline field joint coating for wet insulation field joints

(75) Inventor: Joseph C. Duncan, Katy, TX (US)

Correspondence Address: BRACEWELL & GIULIANI LLP, P.O. BOX 61389, HOUSTON, TX, 77208-1389, US

(73) Assignee: Offshore Joint Services, Inc.

(21) Appl. No.: 11/906,230

(22) Filed: Oct. 1, 2007

Related U.S. Application Data
(60) Provisional application No. 60/848,467, filed on Sep. 29, 2006.

(51) Int. Cl. F16L 11/12

(52) U.S. Cl. 285/47

(57) ABSTRACT

Thermoplastic wet insulation field joints for pipelines in bodies of water utilize the fast gelling nature of thermosetting systems, or other suitable fillers, coupled with a fully fused thermoplastic outer sheath for protecting the pipe joint from water contact. The outer sheath is fully fused circumferentially to the parent coating at each end of the field joint, and an outer closure patch is then fused to the sheath over the joining area and/or injection ports. This totally seals the filler material from direct contact with water, preventing water ingress from reaching the pipe surface. Hydrolysis of the infill material is thus also prevented. By use of a fast setting or solid infill material the system gains sufficient strength almost immediately to withstand the rigors of handling during the lay operation.

### REFERENCE TO RELATED APPLICATIONS

This application claims the benefit of U.S. Provisional Patent Application Ser. No. 60/848,467 which was filed Sep. 29, 2006.

### BACKGROUND OF THE INVENTION

1. Field of the Invention

The present invention relates to field joint coating and infill of the uncoated area of welded pipelines/flowlines for subsequent placement, such as being laid in bodies of water, entrenched or buried or the like.

2. Description of the Related Art

As offshore oil and gas recovery goes into sub sea formations in deeper bodies of water, wells in these formations are producing higher temperature hydrocarbon products at much higher pressures. The wells in deeper bodies of water have usually been located further out from host processing facilities and the subsequent connecting flowlines and pipelines between the wells and the processing facilities have become longer. The deeper water depths and longer connecting pipelines and flowlines have meant that keeping the fluids flowing and preventing adverse conditions, have become more important. Example adverse conditions to be avoided are wax deposits building up and hydrate formation within the line. In an attempt to alleviate these problems, so-called wet insulation systems on the exterior of the pipeline have been developed. Wet insulation is on the outside of the pipeline and thus exposed to the water and hydrostatic pressure, as against pipe in pipe, or “dry” insulation.

These wet insulations are generally based around solid, syntactic or foamed polymeric materials such as polypropylene, polyethylene or polyurethane, although other materials may have also been used embodied, such as nylon, PTFE, epoxies and other thermoplastic or thermosetting materials.

As with pipelines in shallower water depths, the pipes are generally supplied in 12 meter coated lengths and the exposed metal ends of the pipe extending beyond the coating are welded together, forming the joined lengths into a continuous line. Each welded joint is commonly known as the field joint area. More recently, this welding operation may have taken place before the factory coating was applied, turning them into double joints and thus eliminating one field joint. The pipe lengths for such pipelines are usually coated along their lengths, except for the exposed metal ends, with some fluid impermeable polymer or insulation as the protective coating, often known as the parent coating. To ensure that the welded area of pipe is adequately protected against corrosion, and where insulation is necessary to ensure that the area does not act as a cold spot in the line, the field joint must act in a similar fashion to that of the pipeline coating.

Typical offshore industry pipe coatings proposed for anticorrosion control have varied from coal tar enamels, bitumen, powdered coatings, such as fusion bonded epoxy (FBE), to what are known as three layer polymer systems. Each of these systems is compatible with cathodic protection (CP) systems and has used anodes as a back-up for corrosion control in case of coating or field joint damage or breakdown. Where anodes can be used it has meant that little attention has been paid to integrity of the field joint coating. The reason for this has been that since even if the anticorrosion coatings broke down, there would usually be sufficient protection given by the anodes so that no corrosion would occur. However, in the case of thick wet insulation systems the use of anodes as a secondary anticorrosion system can be impractical. The very thick insulation can shield the anode from working efficiently. There are therefore competing design considerations, a need for more secure anticorrosion protection in the field joint area and a need for a thicker thermal barrier field joint.

To achieve more secure anticorrosion and provide a thermal barrier with an integrity like that of the pipeline coating, with a thermosetting polyurethane wet insulation, the field joint has tended to be a base fusion bonded epoxy or a primer layer followed by a casting of a fast gelling two part polyurethane system, similar or identical to the parent coating. This allowed for rapid field jointing due to the rapid setting of the material to match the welding rate and lay speed of the pipe laying vessel. By proper preparation of the parent coating a fully compatible field joint can usually be achieved, one which is capable of being laid immediately after casting as well as offering end to end coating integrity.

However, in the case of thermoplastic insulation, the design of field joint is more complicated. The use of fast setting polyurethane was thought feasible, but the use of dissimilar materials is often problematic. The polypropylene parent surface had to be specially treated to achieve a bond between the dissimilar materials. The dissimilar materials means that the quality of bond is questionable and may lead to breakdown of the interface bond and hence, water ingression down the interface chamfer to the pipe wall surface is possible. This in turn would subject the polyurethane to hot water at the pipe interface which in turn could then attack the polyurethane and cause subsequent failure of the joint.

To overcome this, a system of polypropylene injection on top of fusion bonded epoxy and adhesive has been developed which fully fuses the infill polypropylene to the parent coating, thus eliminating any track for water to penetrate to the pipe surface. In addition, unlike polyurethanes, polypropylene is not subjected to hydrolysis. This normally affords total end to end integrity. This type of system is slow, in that it takes several hours for the infill to fully solidify. As a consequence, this type of system is not compatible with many offshore deep water pipe lay methods.

### SUMMARY OF THE INVENTION

Briefly, the present invention provides a new and improved field joint coating and infill of the uncoated field joint area of welded pipelines/flowlines otherwise covered along their lengths with thermoplastic wet insulation for subsequent placement in bodies of water. The present invention utilizes the fast gelling nature of thermosetting systems, or other suitable fillers, coupled with a fully fused thermoplastic outer sheath. The outer sheath is fully fused circumferentially to the parent coating at each end of the field joint and an outer closure patch is then fused to the sheath over the joining area and/or injection ports. This totally seals the filler material from direct contact with water, preventing any water ingress reaching the pipe surface and hence preventing any hydrolysis or breakdown of the infill material. By use of a fast setting or solid infill material, the system gains sufficient strength almost immediately to withstand the rigors of handling during the lay operation.

### BRIEF DESCRIPTION OF THE DRAWINGS

FIG. 1 is an isometric view, taken partly in cross-section, of a pipeline field joint for wet insulation on a pipeline which is to be coated according to the present invention.

FIG. 2 is an isometric view of a mold according to the present invention for receiving and applying a thermoplastic outer sheath or sleeve of the pipeline field joint.

FIG. 3 is another isometric view of the mold structure of FIG. 2.

FIG. 4 is a top view of the mold structure of FIG. 3.

FIG. 5 is an isometric view of a thermoplastic outer sheath or sleeve for application to a pipeline field joint according to the present invention.

FIG. 6A is an isometric view of the sheath of FIG. 5 in the mold structure of FIGS. 2 and 3 with the mold in an open position.

FIG. 6B is an isometric view of a heating array located in the structure of FIG. 6A for applying heat to the sheath with the mold structure in a closed position.

FIG. 7 is an isometric view of a heater array according to the present invention for heating end or overlap portions of the parent wet insulation coating of the pipe sections adjacent the field joint of FIG. 1.

FIG. 8 is an isometric view of a mold for applying a thermoplastic closure patch to the outer sheath or sleeve on the pipeline field joint according to the present invention.

FIG. 9 is an isometric view of a heating array for heating the thermoplastic closure patch and the portions of the outer sheath or sleeve on the pipeline field joint according to the present invention.

FIG. 10 is a plan view of the mold of FIG. 8 and the heating array of FIG. 9 in position for heating the thermoplastic closure patch and the portions of the outer sheath or sleeve on a pipeline field joint according to the present invention.

FIG. 11 is an isometric view of a completed field joint coating with an applied outer sheath and closure patch on a pipeline field joint according to the present invention.

### DETAILED DESCRIPTION OF THE PREFERRED EMBODIMENTS

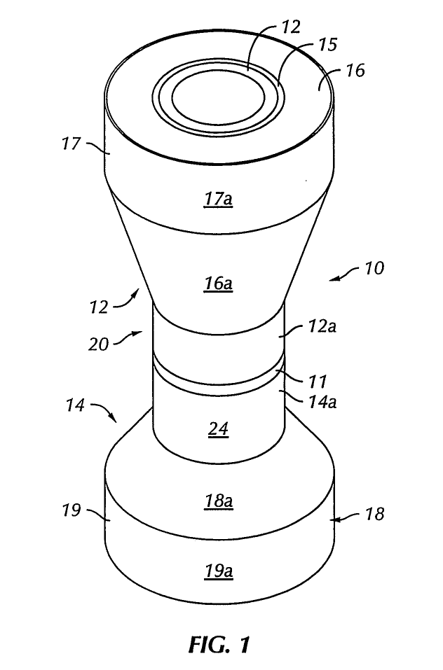

In the drawings, a pipeline 10 is shown (FIG. 1) formed by welding two pipe sections 12 and 14 which are covered by a parent coating 16 and 18, respectively. As shown at 11, the pipe sections. The pipeline 10 is typically one being laid in a relatively deep body of water and is thus shown extending generally in a vertical direction in which the pipeline 10 moves downwardly from a pipe laying barge, J-lay equipment or other suitable vessel into the body of water. It should be understood that the present invention may also be used in connection with S-lay pipeline methods or with reel lay installations, as well. Thus, the pipeline 10 may also extend generally horizontally during the pipe laying operation.

The parent coatings 16 and 18 associated with the pipe sections 12 and 14, respectively, are formed from a suitable thickness of insulated polymer, such as polypropylene, encased within an outer coat material or cover 17 and 19, respectively, also typically of polypropylene. It should be understood, however, that other thermoplastic polymeric materials such as polyethylene or polyurethane may be used as parent coatings 16 and 18. It should also be understood that other suitable synthetic resins such as nylon, polytetrafluorethylene (PTFE), epoxies and other thermoplastic materials may be used as parent coatings, as well. The parent insulated coatings 16 and 18 cover the pipe sections 12 and 14 circumferentially and longitudinally except for a stub end portion of each pipe end 12a and 14a, respectively. The pipe ends or stubs 12a and 14a are exposed and extend from the parent coatings 16 and 18 to facilitate welding as shown at weld seam 11 of the two pipe sections 12 and 14 together as sections of the pipeline 10. However, the exposed pipe stubs or ends are not coated with insulation coating in the pipeline 10.

A gap or joint 20 is thus present after joint welding at the location of the exposed pipe ends 12a and 14a. It is conventional practice to form a tapering chamfer area, such as shown at 16a and 18a, at the end portions of the respective coatings 16 and 18 extending beyond the outer covers 17 and 19. This is done so that a greater surface area is present for receiving a pipe joint infill coating. It is normally the case for deep water or wet insulated pipelines that the gap or joint 20 is filled with an injected high density, water impermeable, polyurethane infill coating. In some cases, a square end extending perpendicularly to the pipe surface may be present rather than tapering chamfer areas 16a and 18a.

As will be described below, a joint infill coating is formed by injecting chemical components depending on the desired infill composition. The chemical components are injected within a protective sheath or sleeve 25 extending between the parent coatings 16 and 18 and spanning the gap 10 at the joint 20. The injected components react within the sleeve to form the desired wet insulation field joint infill. It should be understood that other types of liquid or thermosetting material may be used as the infill material, if desired. Further, insulation shells or other insulating materials may be used if desired and also encapsulated.

A corrosion coating 24 of any of several family available types is applied by conventional methods over the welded, exposed pipe ends 12a and 14a after welding and before application of the protective joint insulation of the coating in the gap 20.

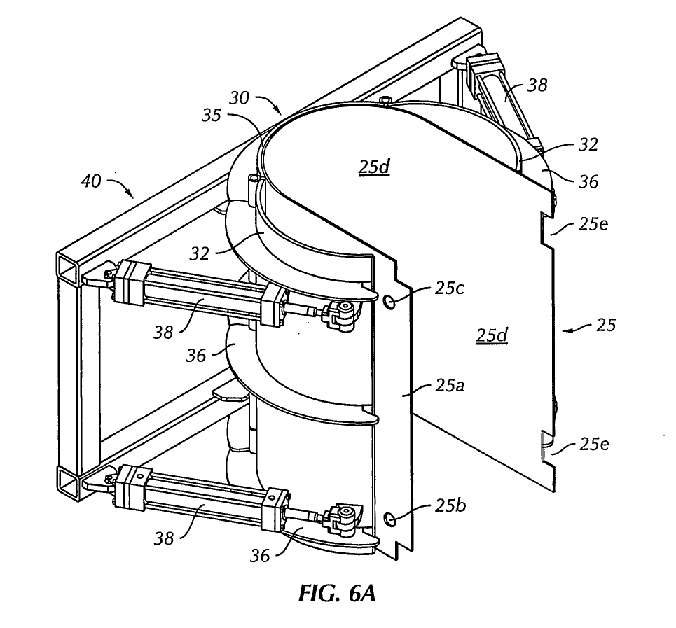

A flat sheet or sheath of polymeric thermoplastic 25 (FIG. 5), preferably an identical or comparable material and grade to the outer coat material 17 and 19 of the line pipe parent coatings 16 and 18, is provided for forming a cylindrical sleeve about the welded pipe joint 20. The sheath 25 is of suitable thickness and of sufficient width to cover the field joint area and overlap onto adjacent cylindrical end areas 17a and 19a of field joint parent coatings 17 and 19. The overlap is typically by a nominal 25 to 100 mm.

The overlap areas 17a and 19a may also be pretreated by abrasion, and by suitable method of changing surface energy, such as flame, corona, etching, or the like. This is done in order for adhesion take place between the infill material and the parent coating. This may not be necessary if no adhesion is required between the coat material 17 and 19 and the outer jacketing sheath. The inner surface of the sleeve may also be treated to facilitate bonding between the infill material and the sheath 25. It should also be understood that the sheath 25 may be formed of preformed thick insulation shells, rather than a more pliable sheet such as shown at 25.

Also, if desired, the bond adhesion formed between the injected components and the parent coating 16 and 18 may be enhanced by a process such as that set forth in applicant's co-pending U.S. Provisional Patent Application “PIPELINE FIELD JOINT COATING FOR WET INSULATION WITH IMPROVED ADHESION”, Attorney Docket No. 085356.000042, filed of even date herewith and claiming priority for U.S. Provisional Patent Application Serial No. 60/848,133 filed Sep. 29, 2006. The subject matter of each such application is incorporated herein by reference for all purposes.

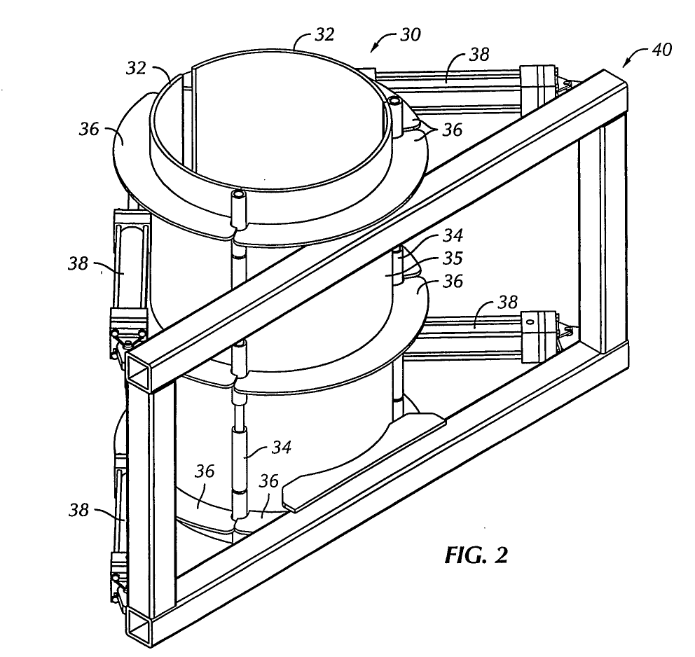

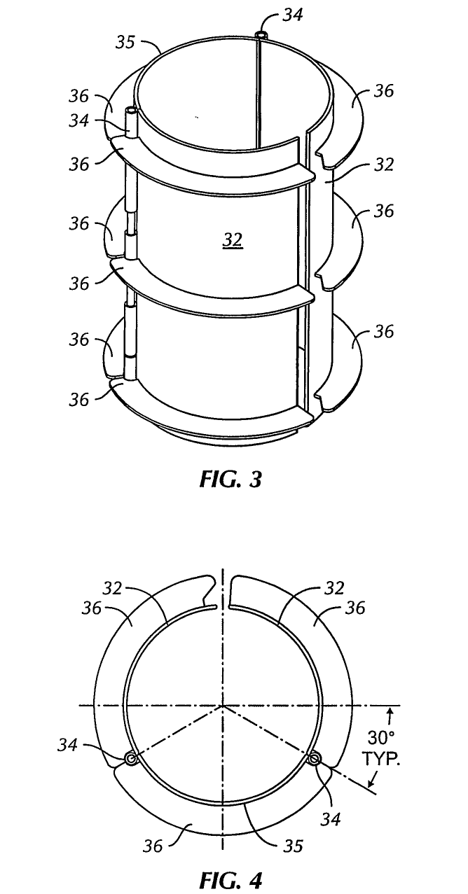

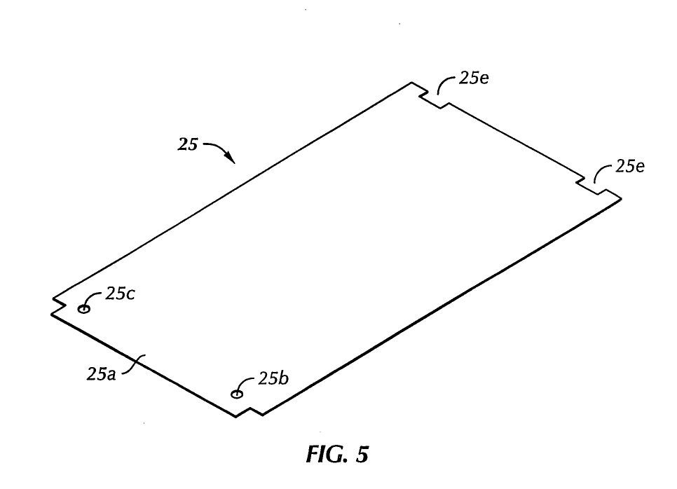

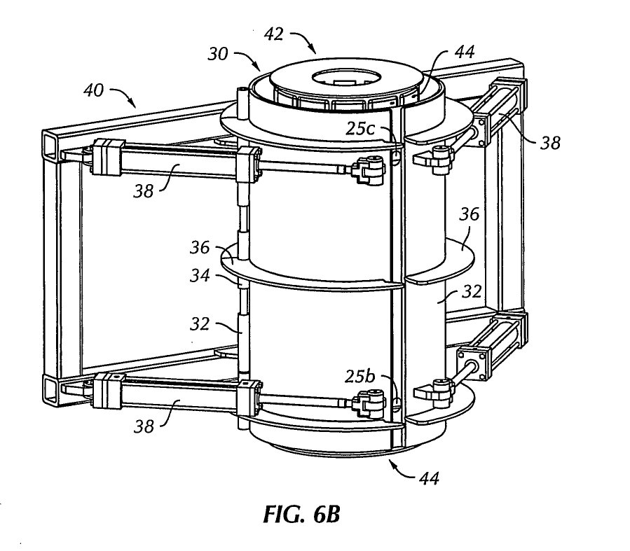

The sheath 25 or shells may or may not be pre-heated prior to being placed in a hydraulically, electrically, or pneumatically operated containment mold 30 (FIGS. 2, 6A and 6B). The sheet is held in position within the mold by vacuum or mechanical gripping, or by clamping or other retention mechanisms.

The mold 30 is generally cylindrical and is formed of several arcuate or curved cylindrical wall segments 32 pivotally connected to each other by hinge pins 34. Circumferentially extending strengthening ribs 36 are preferably included along outer portions of the walls 32 at positions vertically on the mold 30 for additional strength. The arcuate wall segments 32 of the mold 30 are pivotable inwardly and outwardly with respect to a base mold wall section 35 by pistons 38. The pivoting movement may be caused by motors or other suitable movement causing mechanisms, such as hydraulic, electric, pneumatic or otherwise as noted above. The pistons 38 are pivotally connected at their end portions to a support frame 40 to which the mold base wall section 34 is also mounted.

After the sheath 25 is placed in the mold 30 (FIG. 6A) and subjected to force to be held in position, pistons 38 move the wall segments 32 inwardly until the mold 30 is closed (FIG. 6B). The sheath 25 is formed into a cylindrical shape in the mold 30. The sheath 25 has a longitudinally extending flap 25a (FIG. 5) along one edge to form a barrier or closure against leakage of infill components during the infill operation. The sheath 25 also includes a fill port 25b and a vent port 25c, where the sheath is to be filled by a liquid or thermosetting material, for example polyurethane, and the material injected or otherwise caused or allowed to enter through the fill port 25b. Typically, gaps or slots 25e are formed along an opposite edge of the sheet 25 from the flap 25a to insure access to the ports 25b and 25c.

Prior to positioning the sheath 25 on the pipeline 10 to receive the infill material, a cylindrical or pre-shaped heating array 42 (FIG. 6) with a suitable number of heating units 44 is positioned within the preformed cylinder shape 25 within the mold 30. The heating units 44 are arranged in a pair of vertically spaced, inwardly facing, circumferentially disposed arrays. The heating elements 44 are preferably infrared heat sources, but may be of some other form, as hot air, halogen or other suitable heat source.

A circumferential target area 25d (FIG. 6) of the sheet or sheath 25 at an upper and lower end thereof is exposed to heat from the heating array 42 at upper and lower circumferential segments. The target area segments 25d of sheath 25 to be heated match or correspond to the end areas 17a and 19a of parent coating materials 17 and 19. Thus, the target areas 25d of sheet 25 and end areas of 17a and 19a parent coatings 17 and 19 overlap when the sheet 25 is placed over the pipe joint, as will be described. In the case of a three layer infill or insulation shells, the area to receive heat is the entire inner surface area of sheath or shells 25.

The application of electrical power to the heating array 42 for heating target or overlap areas 25d of sheath 25 is controlled and monitored to allow heat output of array 42 to be regulated as to time and temperature. The controlled level of electrical power is applied, and the overlap area 25d of the sheath/shell 25 brought up in temperature until the thermoplastic material areas of interest in the sheath 25 are in the softening phase, which can be monitored or observed by the operator or crew, or a suitable temperature measurement probe.

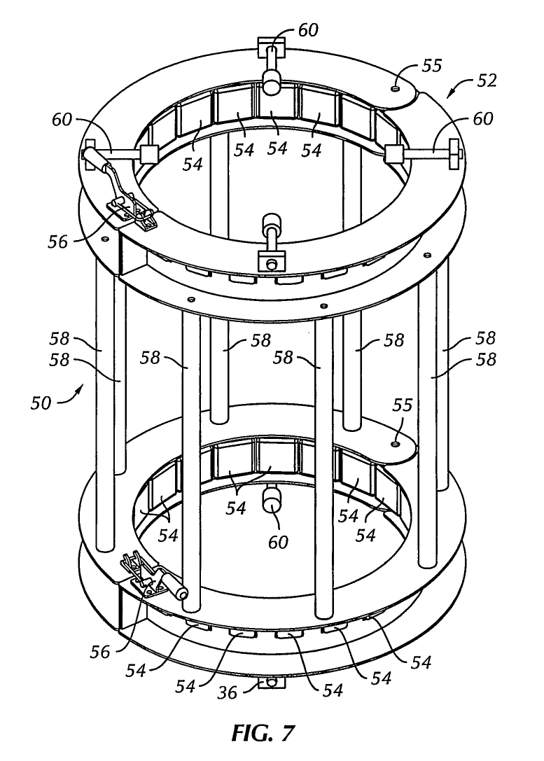

Concurrently with heating the sheath 25 in mold 30, a heating array 50 (FIG. 7) is placed around the overlap areas 17a and 19a of the parent coating material 17 and 19. The heating array 50 is composed of upper and lowers fitting rings 52, each containing a circumferential array of heating elements 54. The elements 54 may be infrared heat sources, or they may be of other types previously mentioned. The elements 54 heat the circumferential extent of the overlap areas 17a and 19a of the parent coating materials 17 and 19. The fitting rings 52 are hingedly connected at hinge pins 55 so that the array 50 may be positioned above the pipe joint 20. Locking clasps or comparable mechanisms 56 are provided on the rings 52 to hold the heating array 50 in place about the pipe joint.

The upper and lower heating array rings 52 are spaced from each other by spacer rods 58, and positioning fingers 60 are mounted on each of the heating array rings 52 to insure proper spacing of the heating elements 54 from the overlap areas 17a and 19a to be heated.

Again, application of electrical power to the heating array 50 is controlled and monitored to allow heat output of the array 50 to be regulated as to time and temperature. When the heating array 50 is in position on the pipe joint and the heating elements 52 are positioned corresponding to the overlap areas 17a and 19a, the first portions of the coating are exposed to heat and the coating brought up in temperature until the softening point of materials 17 and 19 is reached. As mentioned previously, this can be observed visually or by probe, as desired.

In both instances, the thermoplastic materials of the sheath 25 and parent coatings 17 and 19 exposed to heat from the arrays 42 and 50 should not be excessively heated to the point of waxing or oxidizing.

When the upper and lower target surfaces of the sheet 25 are in the correct softening point or phase condition, the mold 30 is opened and the heating array 42 removed. The heating array 50 should also be removed from the parent coatings 17 and 19 at the same time.

The mold 30 containing the sheath 25 is then positioned and closed around the field joint area 20 and pressure applied through the pistons 38. The pressure causes the pre-heated overlap target area 25d of the sheath 25 and the preheated areas 17a and 19a of parent coatings to fuse together. The fused areas form a permanent homogeneous layer which acts as a seal against water ingress.

At this point, infill material can be introduced through fill port 25b into the area within the sheath 25 adjacent the pipe joint. The filler material is thereafter allowed to gel, and the mold 30 is then opened and removed.

The exposed overlap flap 25a of the sheath 25 is then cut off or removed from the pipe joint leaving an exposed seam 27 of filler material extending longitudinally between side edges of the cylindrical sheath 25. Any rough or uneven areas are then smoothed on the surrounding area of the seam 27 of applied infill where the flap 25a has been removed, and in the areas adjacent to fill port 25b and vent port 25c. Such areas are treated by corrective mechanical surface treatment so that the areas are made flush and smooth with the remainder of the gelled filler material.

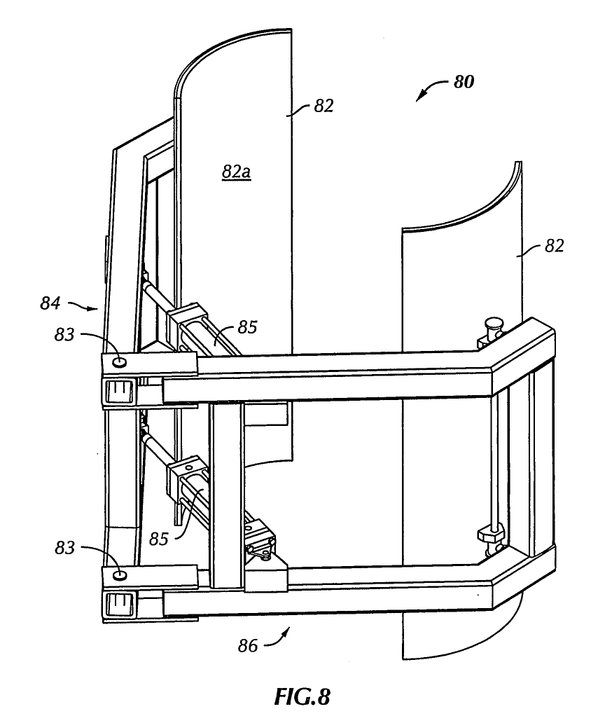

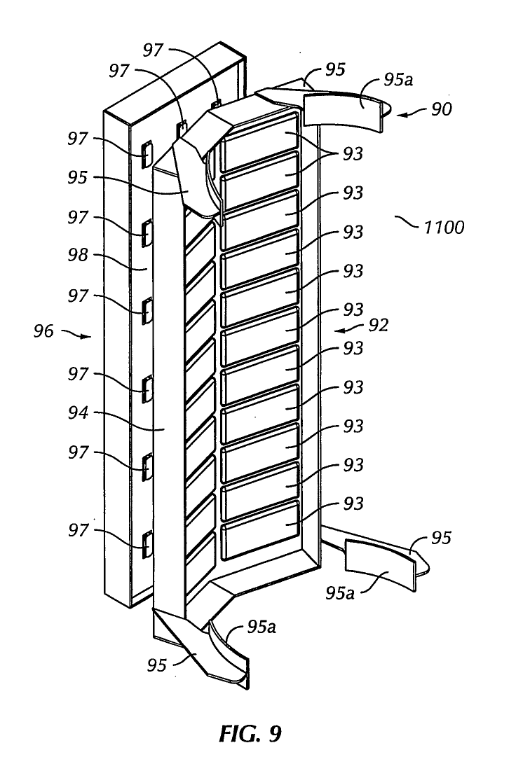

A closure patch mold 80 (FIG. 8) and a heating array 90 (FIG. 9) are then used to apply a closure patch sheet or patch 100 to completely encompass and seal the sheath seam 27 and ports 25b and 25c. The closure patch mold 80 includes a pair of arcuate cylindrical wall segments 82 pivotally mounted at inner ends of clamp arms 84 and 86. The clamp arms 84 and 86 are pivotally connected at pivot pins 83 and are relatively moveable with respect to each other in response to the forces imparted by pistons 85. The wall segments 82 are pivotally connected to the arms 84 and 86 so that cylindrical inner surfaces 82a may engage and mate with cylindrical outer surfaces of the joint infill and sheath.

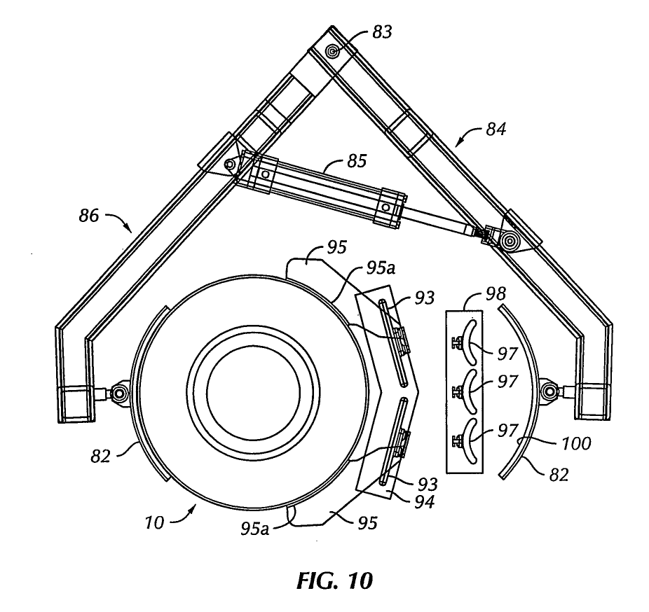

The heating array 90 includes a sheath heating array panel 92 and a closure patch heating array 96 arranged to be positioned (FIG. 10) relatively spaced from each other. Heating array panel 92 includes a number of arranged heating elements 93 positioned corresponding to the location of the seam 27 and adjacent areas of the sheath 25. The heating elements 93 may be of the types previously described. The heating elements 93 receive power controlled as to temperature and time in order to heat those areas of the joint sheath seam 27 and surrounding area to a desired softening temperature. The heating elements 93 are contained in a rack or panel 94 having inwardly extending arms 95 at upper and lower ends thereof. The arms 95 have arcuate engagement surfaces 95a formed thereon shaped for conforming contact with the exterior surfaces of the joint infill and sheath surface area of the seam 27 being heated.

The heating array 90 also includes the outer sheath heater array 96 (FIGS. 9 and 10) which has a suitable number of heating elements 97 mounted therewith in a rack 98. When in use, the heater array 96 is positioned facing in an opposite direction from the heating elements 93 of the sheath heating array panel 92. When in position (FIG. 10), array 96 faces toward the closure patch 100 which is held in place by a suitable mechanical attachment or vacuum forces on one of the wall segments 82 of the closure patch mold 80.

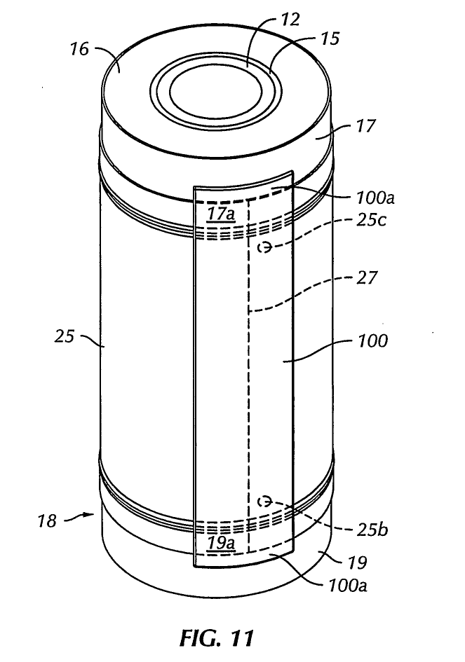

The closure sheet 100 is typically of the same or comparable material as the sheath 25, and is cut to a suitable length and width to fully encompass the circumferential extent of seam or joining area 27. The closure sheet 100 is also of an adequate longitudinal extent (FIG. 11) or length to span the full length at each end as shown at 100a of the sheet 25 and extend beyond onto the coating portions 17 and 19.

The heating array 90 is placed (FIG. 10) such that the inner surface of the closure sheet 100 is exposed to heat from heater array 96 and the seam 27 is exposed to heat from heating elements 93. The seam area 27 and the adjacent sheath 25 and parent coatings 17 and 19 corresponding to the surface area dimensions of the patch 100 are heated to reach a temperature such that the outer surfaces are in the softening zone of the material.

The heating array 90 is then removed and the closure mold 80 activated, moving the wall segments 82 into contact with the sheath 25, closure patch 100 and adjacent segments of the parent coatings 17 and 19 on each side of the closure patch 100. The pistons 85 pressurize the closure patch 100 to the sheath 25 and parent coating overlap regions outside the longitudinal extent of the sheath 25. This causes the closure patch 100 to fully fuse to the sheath 25 and parent coatings 17 and 19. The closure mold 80 is removed once the fused area has solidified. Any excess exuded filler polypropylene material may be removed for cosmetic purposes.

Although not illustrated, it should be understood that the component structures, such as the heater arrays and mold frames illustrated are provided with suitable attachment mechanisms, such as hooks or eyelets. The attachment mechanisms allow the heater arrays and mold frames to be attached, or suspended from, support frames. This is done to allow the various component structures to be moved to and from required positions for the joint infill and sealing operations described herein.

Thus, it can be seen that the present invention provides a new and improved field joint coating and infill of the uncoated field joint area of welded pipelines/flowlines otherwise covered along their lengths with thermoplastic wet insulation for subsequent placement in bodies of water. The present invention utilizes the fast gelling nature of thermosetting systems, or other suitable fillers, coupled with a fully fused thermoplastic outer sheath 25. According to the present invention, the outer sheath 25 is fully fused circumferentially to the parent coatings 17 and 19 on each end of the field joint, and the outer closure patch 100 is then fused to the sheath 25 over the joining area 27 and filler ports 25b and 25c. A total seal of the filler material from direct contact with water is obtained, preventing any water ingress reaching the pipe surface. This also prevents any hydrolysis of the infill material. By use of a fast setting or solid infill material, the present invention gains sufficient strength almost immediately to withstand the rigors of handling during the pipe lay operation.

It should be noted and understood that there can be improvements and modifications invention described in detail above which would be apparent or would be evident to those skilled in this art made of the present based on the teachings herein, and thus encompassed within the inventive concepts and suggestions contained herein, without departing from the spirit or scope of the present invention.

What is claimed is:

1. A method for applying a fluid impermeable protective coating at a welded pipe joint connection on a pipeline having a polymer parent wet insulation coating, and being laid beneath a body of water, comprising the steps of:
heating cylindrical end areas of the parent coating adjacent the welded pipe joint connection;
heating cylindrical end area portions of a sheath of synthetic resin;
fusing together the cylindrical end areas of the synthetic resin sheath and the heated cylindrical end areas of the parent coating to form a cylindrical sleeve about the welded pipe joint connection;
introducing at least one component into the interior of the cylindrical sleeve as an infill material therein about the welded pipe joint connection;
heating a closure strip to be applied over a seam at edges of the cylindrical sleeve extending longitudinally between the fused end areas of the parent coating and the cylindrical sleeve;
heating a surface area of the infill material extending longitudinally along the seam; and
fusing together the heated sealant strip and the heated surface area of the infill material to seal the protective coating and the welded joint from contact with the water.

2. The method of claim 1, wherein the step of fusing is performed by heat fusion.

3. The method of claim 1, wherein the step of fusing is performed by applying pressure to the closure strip and surface area.

4. A pipeline field joint protective coating for attachment at positions protecting exposed pipeline joint sections on underwater pipelines having a polymer parent wet insulation coating, the protective coating comprising:
a sheet of a polymeric thermoplastic cover material having target areas formed at end portions for fusion with the parent coating at positions overlapping adjacent end portions of the parent coating, enclosing the exposed pipeline joint sections;
the sheet polymeric thermoplastic cover material being fused in place with the adjacent end portions of the parent coating forming an annular space around the pipeline joint sections sealed against water ingress;
the sheet of polymeric thermoplastic cover material being wrapped in a cylindrical shape and having adjacent longitudinal side edges to form a longitudinal seam along the annular space;
the sheet of polymeric thermoplastic cover material having a fill port therein for passage of fill material into the annular space; and
a closure strip fused with the sheet of polymeric thermoplastic cover material and overlapping the longitudinal seam to form a seal against water ingress at the longitudinal seam.

5. The pipeline field joint protective coating of claim 4, wherein the fill port in the sheet of polymeric thermoplastic cover material is located at a position beneath the closure strip.

6. The pipeline field joint protective coating of claim 4, further including a vent port formed in the sheet of polymeric thermoplastic cover material.

7. The pipeline field joint protective coating of claim 6, wherein the vent port in the sheet of polymeric thermoplastic cover material is located at a position beneath the closure strip.

8. The pipeline field joint protective coating of claim 4, further including the sheet of polymeric thermoplastic cover material being pretreated to facilitate bonding.

9. An apparatus for preparing a sheet of polymeric thermoplastic for application as a joint infill coating by fusion to a polymeric parent wet insulation coating for an offshore pipeline, comprising:
a plurality of pivotally connected wall segments defining a curved inner wall for receiving the sheet of polymeric thermoplastic;
a support frame having the wall segments mounted therewith;
a movement mechanism for moving the wall segments to form the sheet of polymeric thermoplastic into a cylindrical shape; and
a heat source positioned within the cylindrical sheet of polymeric thermoplastic inside the wall segments.

10. The apparatus of claim 9, wherein the sheet of polymeric thermoplastic has target areas formed at end portions for fusion with the parent coating, and further including:
a heating array of spaced circumferentially extending heating elements adapted to be positioned adjacent the target areas of the sheet of polymeric thermoplastic to heat same for fusion with the parent coating.

11. An apparatus for applying a closure strip to form a seal against water ingress at a longitudinal seam between adjacent longitudinal side edges in a sheet of polymeric thermoplastic cover material being wrapped in a cylindrical shape for attachment at positions protecting exposed pipeline joint sections on underwater pipelines having a polymer parent wet insulation coating, the apparatus comprising:
a pair of pivotally movable clamp arms;
a curved wall segment mounted with each of the clamp arms, at least one of which is adapted to receive the closure strip thereon;
a heating element array located facing the closure strip to heat same for fusion with the sheet of polymeric thermoplastic cover material.

12. An apparatus for applying a sheet of polymeric thermoplastic as a joint infill coating by fusion to a pipe joint in a polymeric parent wet insulation coating for an offshore pipeline, comprising:
a plurality of pivotally connected wall segments defining a curved inner wall for receiving the sheet of polymeric thermoplastic;
a support frame having the wall segments mounted therewith;
a movement mechanism for moving the wall segments to form the sheet of polymeric thermoplastic into a cylindrical shape; and
a heat source positioned within the cylindrical sheet of polymeric thermoplastic inside the wall segments to treat the sheet for fusion;
the wall segments being movable in response to the movement mechanism to an open position for movement onto the pipe joint;
the wall segments being movable to a cylindrical position enclosing the pipe joint to form a cylindrical sleeve for fusion to the parent wet insulation coating.

13. The apparatus of claim 12, wherein the sheet of polymeric thermoplastic has target areas formed at end portions for fusion with the parent coating, and further including:
a heating array of spaced circumferentially extending heating elements adapted to be positioned adjacent the target areas of the sheet of polymeric thermoplastic to heat same for fusion with the parent coating.
